(19) United States
(12) Patent Application Publication
(10) Pub. No.: US 2011/0038597 A1
(43) Pub. Date: Feb. 17, 2011

(54) METHOD AND APPARATUS FOR ASSOCIATING METADATA WITH CONTENT FOR LIVE PRODUCTION

(75) Inventors: Benjamin McCallister, Jacksonville, FL (US); Alex Holtz, Jacksonville, FL (US)

Correspondence Address: Robert D. Shedd, Patent Operations;THOMSON Licensing LLC, P.O. Box 5312, Princeton, NJ, 08543-5312, US

(73) Assignee: Thomas Licensing, Issy Les Moulineaux (FR)

(21) Appl. No.: 12/736,509

(22) PCT Filed: Apr. 14, 2009
(86) PCT No.: PCT/US2009/002326

§ 371 Date: Oct. 12, 2010

Related U.S. Application Data
(60) Provisional application No. 61/123,917, filed on Apr. 14, 2008.

(51) Int. Cl. H04N 9/80

(52) U.S. Cl. 386/239; 386/E09.011

(57) ABSTRACT

A system for line production of a television show can include a newsroom computer system (NRCS 14) which includes a mark-up tool that allows a user to specify temporal metadata corresponding to temporal events contained within a content segment for repurposing content. Through the use of the mark-up tool, a journalist or web producer can use their existing NRCS, or the like, to specify the static, temporal and distribution metadata needed in the production process. Thus, in the event of a change during production, the NRCS can accurately and automatically repurpose the content using previously established temporal metadata.

### CROSS-REFERENCE INFORMATION

This application claims priority under 35 U.S.C. 119(e) to U.S. Provisional Patent Application Ser. No. 61/123,917, filed 14 Apr. 2008, the teachings of which are incorporated herein.

### TECHNICAL FIELD

The present invention relates to re-purposing content using metadata associated with the content.

### BACKGROUND ART

The biggest challenge in preparing content for distribution is dealing with source material that has little or no temporal metadata associated with it. Examples include live news, talk shows, sporting events and other dynamic activities that by their nature cannot follow a rigid timing sequence. Although there are automated tools to detect scene changes in source video, the actual produced content segments typically have many such transitions as part of the content itself.

Therefore, difficulties arise in differentiating between basic scene changes in the source content and the actual start and end to a desired segment.

### BRIEF SUMMARY OF THE INVENTION

In accordance with a first embodiment of the present principles, there is provided a method for associating metadata with audio-visual content. The method commences, upon receipt of at least one content segment, by establishing metadata needed to repurpose the content segment for distribution. The established metadata gets automatically associated with the at least one content segment. Thereafter, the at least one content segment gets repurposed for live distribution in accordance with the established metadata.

### BRIEF DESCRIPTION OF THE DRAWINGS

FIG. 1 depicts a block schematic diagram of a system for practicing the content insertion method of the present principles;

FIG. 2 depicts a flow diagram of a method in accordance with the present principles for repurposing content;

FIG. 3 depicts a flow diagram of an exemplary method for modifying a show according to the present principles;

FIG. 4 depicts a flow diagram of an exemplary method for modifying a content segment according to the present principles; and

FIG. 5 depicts a flow diagram of an exemplary method for implementing a new Transition Macro Event according to the present principles;

### DETAILED DESCRIPTION

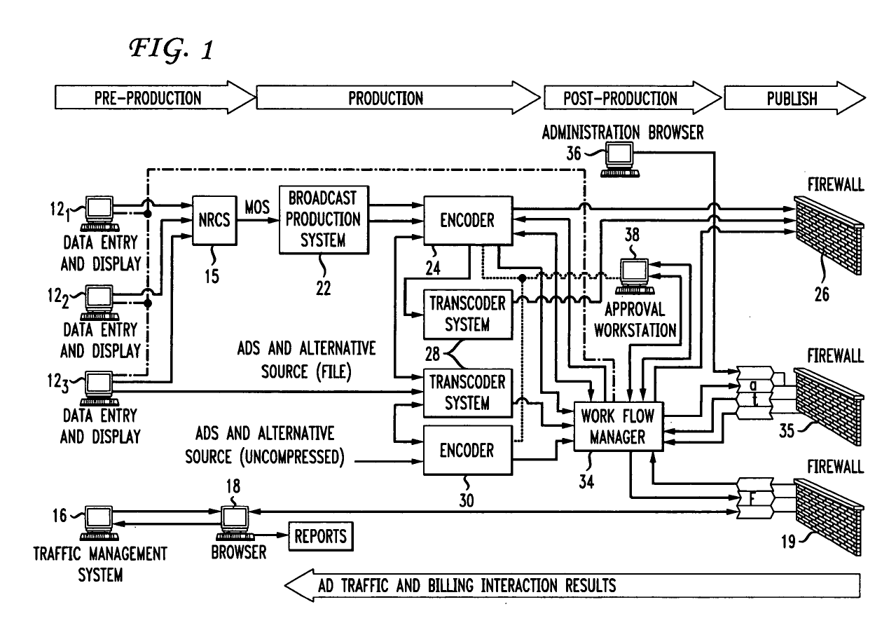

FIG. 1 depicts a block schematic diagram of a live show production system 10 in accordance with an illustrative embodiment of the present principles for repurposing content from a live show for distribution via a communications mode, for example, but not limited to, Internet distribution. Live production of a show typically has the following phases:

1. Pre-production;

2. Production;

3. Post-Production; and

4. Publication

To facilitate understanding of the live show production system 10, the elements of the system will be described with respect to their roles in connection with (1) pre-production; (2) production; (3) Post-production; and (4) publication. Steps 2 and 4 can interact both with advertising traffic and billing activities.

### Pre-Production

The pre-production phase of live content production for a show such as a television new program usually entails the gathering of content segments (e.g., news stories) and associated metadata. To facilitate pre-production of a live show, the live show production system 10 includes at least one and preferably a plurality of data entry and display apparatus, each enabling an operator to enter data and receive displayed information with respect to at least the following activities:

(1) Web production and editing;

(2) Newsroom production; and

(3) Digital news production and asset management.

An operator could make use of a single data entry and display apparatus to enter data and receive information with respect to all three activities (as well as other functions). In practice, different operators often handle (1) web production and editing; (2) newsroom production; and (3) digital news production and asset management, via a corresponding one of data entry and display apparatus 12₁, 12₂ and 12₃, respectively. Each of the data entry and display apparatus 12₁, 12₂ and 12₃ typically takes the form of a conventional video display terminal having an associated keyboard. Alternatively, the data entry and display apparatus 12₁, 12₂ and 12₃ could take different forms, such as desk top or lap top computers, Personal Data Assistants (PDAs) or the like. To the extent that that one or more of (1) web production and editing; (2) newsroom production, and (3) digital news production and asset management activities, requires more than one operator, the live show production system 10 could include additional data entry and display apparatus associated with that activity.

The data entry and display apparatus 12₁-12₃ each link to a news room computer system (NRCS) 14. The NRCS 14 typically includes one or more processors (not shown) and one or more servers (not shown), as well as other devices, all operating under one or more control programs that serve to automate various activities associated with news gathering. For example, the NRCS 14 typically manages and tracks story assignments as among various individuals such as reporters, camera operators and the like. Additionally, the NRCS 14 serves as the point of entry (e.g., the ingest point) for news stories, transcripts and metadata to drive both the automated broadcast system 22 and the encoder 24. Further, the NRCS 14 affords news room personnel, including reporters and editors, the ability to perform at least some editing operations, including the addition of graphics triggered by the automated broadcast system 22 or by the workflow manager 34, thereby allowing such personnel to create content segments stored by the NRCS 14.

As discussed earlier, a live show typically includes one or more advertisements for play out between content segments. Most television stations employ one or more systems, best exemplified by the traffic management system 16, for managing the scheduling of advertisements in terms of the time at which they appear as well as billing of the costs to the parties who contracted for the play-out of such advertisements. Typically, a television station will charge different amounts for advertisements depending on the program in which such advertisements appear. Thus, programs that have many viewers typically command higher advertising rates than less popular programs. By the same token, programs that appear during certain times also can command higher advertising rates than programs that appear during other times. Further, certain segments of the newscast, i.e., weather, top stories, sports, might draw higher revenue than other portions of the newscast.

The traffic management system 16 enjoys a link to a browser 18, typically taking the form of a video display terminal or a personal computer and associated display for providing reports as well as for providing an interface between the traffic system and other elements (described hereinafter) within the system 10. The browser 18 also links to a firewall 19 to enable users with appropriate permission to remotely access the traffic and billing information.

### Production

The production phase of live show production generally entails the creation and subsequent execution of a script to assemble and play out a succession of content segments. As an example, production of a live television news program typically entails the play out of previously recorded content segments interspersed with live shots and accompanying audio of on-air talent, live shots of reporters in the field, and or live network feeds. To facilitate the “production” phase, the system 10 includes a broadcast production system 22 that provides either via a standard manual workflow or an automated work flow, such provided in the Ignite Automated Production System available from Thomson Grass Valley, Jacksonville, Fla. The broadcast production system 22 receives content segments from the NRCS 14 which pass typically via the Media Object Server (MOS) Protocol. The broadcast production system 22 typically comprises the combination of one or more computers and associated peripherals such as storage devices, as well one or more broadcast production devices (not shown), such as cameras, video switchers, audio mixers, to name but a few, all under the control of such computer(s). The broadcast production system 22 controls the creation and assembly of content segments into a script for automated rundown (e.g., execution of that script) to create a television program for distribution (i.e., publication). To facilitate the live show “production” phase, the live show production system 10 of FIG. 1 also includes a first encoder 24 capable of encoding live audio visual content generated by the automated broadcast system 16 using a particular coding format, such as Windows® Media Video (WMV), to facilitate the transmission of such content to a first firewall 26 for subsequent distribution to subscribers across the Internet or one or more other networks, such as LANs and WANs. A transcoding system 28 transcodes the encoded content from the encoder 24 into other formats such as MPEG 2, H.264 and Apple® Quick Time, to name but a few, to facilitate the transmission of content encoded in such formats to the firewall 26 for subsequent distribution via one or more channels, such as terrestrial over-the-air broadcast and/or distribution over satellite and or cable television systems. The transcoding system 28 also has the ability to specify pre-roll or post-roll content which will be stitched directly into the output file. The Pre-roll or Post-Roll content can either be advertisements or promotional clips which have been stored in the workflow manager 34.

The live show production system 10 of FIG. 1 can include a second encoder 30 for encoding advertisements and alternative source material in uncompressed form into a given format, such as the Windows® Media Video format for distribution to the fire wall 26 for subsequent distribution over the Internet. Additional transcoders (not shown) can be added to the transcoding system to allow asynchronous processing of multiple transcodes.

### Post-Production

The “post-production” phase of live show production typically involves the manipulation of content to perform certain tasks, such as editing for example. In the illustrated embodiment of the live show production system 10 of the present principles, such content manipulation can include the insertion of an advertisement, or even new content into a time slot between successive content segments.

To facilitate the “post-production” phase of live television program creation, the system 10 of FIG. 1 includes a work flow manager 34, typically in the form of programmed computer or the like linked to the data entry and display apparatus 12₁, 12₂ and 12₃ as well as to the encoders 24 and 30 and the transcoding system 28. The work flow manager 34 performs various tasks including the management and storage of advertisements, as well as manipulation of content segments to facilitate insertion of an advertisements into a given time slot between content segments. The work flow manager 34 also serves as an interface to digital news production systems (not shown); content streaming systems (not shown) and administration systems (not shown). The work flow manager 34 enjoys a link to a firewall 35 which enables users having appropriate permissions to gain remote access to information generated by the work flow manger.

At least one administration browsing apparatus 36, typically in the form of a video terminal and associated keyboard, links to the work flow manager 34 to enable an operator to access the work flow manager to perform various tasks including controlling content management and distribution. At least one approval work station 38 also possesses a link to the work flow manager 34 to enable an operator to review both live and non-linear edited content and grant approvals for publication.

### Publication

The “publication” phase of live show production typically entails the distribution of content to viewers. Traditionally, distribution of a television program produced live entailed terrestrial transmission over the air or transmission to one or more satellite or cable systems. As discussed above, the live show production system 10 advantageously can distribute content over one or more networks, such as the Internet. To facilitate publication (i.e., distribution), over the Internet, the system 10 includes the firewall 19 which, as described previously, serves as a portal to pass television programs to interested subscribers. As discussed, the firewalls 26 and 35 enable users with appropriate permissions to access the live show production system 10 to obtain certain information related to system operation.

A described in greater detail hereinafter, the live show production system 10 can dramatically improve the efficiency of producing live content, and particularly, the re-purposing of such content for distribution (e.g., deployment) via the Internet and other similar distribution mechanisms such as those which employ Internet Protocol or other data protocols.

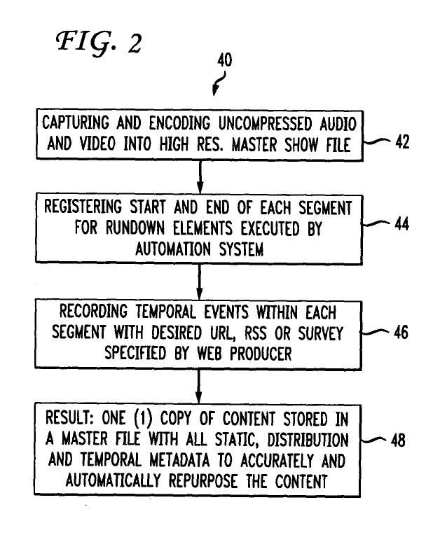

Instead of staffing up the postproduction process to repurpose content faster by brute force, the technique of the present principles enables completion of at least some of the repurposing tasks before completing production of the newscast. As discussed above, the (NRCS) 14 handles the preproduction of live news. In practice, the NRCS could take the form of the iNews™ or AP ENPS™ available from Avid of Tewksbury, Mass. Using the NRCS, journalists enter their stories and associate content as needed. The NRCS 14 includes a markup tool specific for repurposing content, thereby allowing the journalist or web producer to use their existing NRCS system to specify the static, temporal and distribution metadata needed in the production process. As described in greater detail in FIG. 2, the mark-up tool performs various functions to record temporal events to establish metadata for association with the content.

### Live Content Production

Once content, (the audio-visual information that comprises a television show such as but not limited to a news program), gets marked up with all the necessary production metadata, the broadcast production system 22 of FIG. 1 system can import the content from the NRCS 14 and run the content with time accurate results. As the content runs, uncompressed audio and video get captured and encoded into the high resolution master show file needed for repurposing the content in postproduction

Static and distribution metadata get entered in the preproduction process for the content and each content segment can undergo review and ultimately get carried through to postproduction for a seamless workflow. However large efficiencies in work can result by the addition of accurate temporal metadata inserted into the workflow by the broadcast production system 22. The start and end of each content segment undergo registration as segments for execution by the broadcast production system 22. Temporal events within each segment get accurately recorded with the desired URL, RSS or survey specified by the web producer. The result of such activities yields at least one copy of the content stored in a master file with all the static, distribution and temporal metadata to accurately and automatically repurpose the content.

FIG. 2 depicts in flow chart form the steps of an exemplary for repurposing of content according to the present principles. As mentioned above, the uncompressed audio and video undergo capture and encoding to yield a high resolution master show file during step 42. The start and end of each segment undergo registration during step 44. The temporal events, as well as all associated metadata within each segment get recorded with the desired URL, RSS or survey specified by the web producer during step 46. The recording step yields a copy of content (element 48 in FIG. 2) stored in a master file with all static, distribution and temporal metadata to enable accurate and automatic repurposing of the content. As described in greater detail below, the metadata can include any or all of the following information such as show level settings, show titles, show sub-titles, content rating, content destination, network affiliation, copyright information and disclaimer information, by way of example. The metadata can include other information in place of or in addition any or all of the items identified previously.

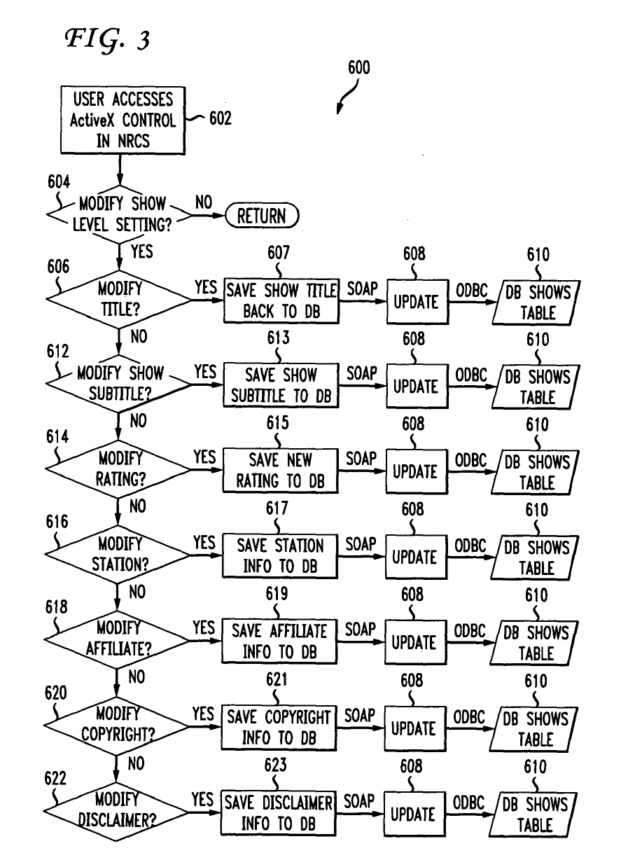

FIG. 3 depicts in flow chart form the steps of a method 600 for modifying content comprising a television show using the exemplary level settings. All settings for the television show should be savable. This process begins when the Web Producer selects a “Show” tab in a graphical user interface (not shown) associated with the live show production system 10 of FIG. 1 during step 602, typically using the well known ActiveX control. At this point, a check occurs during step 604 to determine whether or not to modify show level setting. If yes, the process proceeds to step 606. The default for the show title should get displayed for the user. This title gets generated automatically based on the template which is to be prepared. Consider the following example: A user prepares a template associated with a newscast to appear at 6 PM. The output name would appear as “6 PM Newscast Thursday 09/11/07”. The user should possess the ability to change the title so that upon show preparation, the user-modified title becomes substituted instead. Once modified, the show title gets saved during step 607 to a database 610, and the broadcast production system 22 of FIG. 1 updates itself during step 608. As will be evident from the following, when any modification title modification occurs, the modification gets saved and display of the database 610 occurs in response to the modification.

A user can modify a show sub-title and once such modification gets detected during step 612, the modified sub-title gets saved to the database 610 during step 613. Thereafter, the broadcast production system 22 of FIG. 1 updates itself during step 608. The database 610 will show modified sub-title.

The template used at the time of Show Preparation will automatically specify the rating for the show. However the user can specify show level ratings which indicate the rating of the Over-The-Internet live broadcast. A drop down box will display the possible ratings, allowing the user to select, G, PG, PG-13, etc. A user can modify a show rating and once such modification is detected during step 614, the modified rating gets saved to the database 610 during step 615. Thereafter, the broadcast production system 22 of FIG. 1 updates itself during step 608. The database 610 will show modified rating.

The database 610 contains a setting which denotes the television station or other source station from which the content originates. However, in the case that the Web Producer wishes to provide content to an affiliate, or simply syndicate in some fashion other than standard deployment, the Web Producer should possess the ability to specify a different content source. The user should possess the ability to establish, at commissioning, a list of stations for which the broadcast production system 22 can produce content. The station list will appear in a drop down box under ActiveX control. However, the user should also possess the ability to manually specify a station within a text box. Thus, a user can modify a content source and once such modification gets detected during step 616, the modified station gets saved to the database 610 during step 617. Thereafter, the broadcast production system 22 of FIG. 1 updates itself during step 608. The database 610 will show modified station.

The database 610 also contains information regarding network affiliation of the television station that produced the content which normally, gets assigned automatically at the outset of preparing a show. However, again, the Web Producer should possess the ability to override the values specified automatically. Thus, a user can modify the affiliation and once such modification gets detected during step 618, the modified affiliation gets saved to the database 610 during step 617. Thereafter, the broadcast production system 22 of FIG. 1 updates itself during step 608. The database 610 will show modified affiliation.

The database 610 stores Copyright information which typically allows for global content distribution. However, in the case of providing content for non-standard distribution, the Web Producer should have the ability to modify the default copyright for this show. A drop down box will list all available pre-defined copyrights. Thus, a user can modify the copyright information and once such modification gets detected during step 620, the modified copyright information gets saved to the database 610 during step 621. Thereafter, the broadcast production system 22 of FIG. 1 updates itself during step 608. The database 610 will show modified copyright information.

A user should have the ability to either select from the default disclaimer specified in the database, or manually enter, via textbox, a different disclaimer. Upon detecting a modified disclaimer during step 622, the modified disclaimer information gets saved to the database 610 during step 617. Thereafter, the broadcast production system 22 of FIG. 1 updates itself during step 608. The database 610 will show modified disclaimer information.

Segment data information gets stored directly into the NRCS 14 of FIG. 1. Information for the segment appears in MOS formatted messages which get embedded directly into the script text field of the Page within the NRCS 14. When a user selects a story, the user should possess the ability to see the MOS formatted message within the script text and have the ability to double click the MOS message. At this point, the ActiveX control should instantiate with all applicable information for the content within that story.

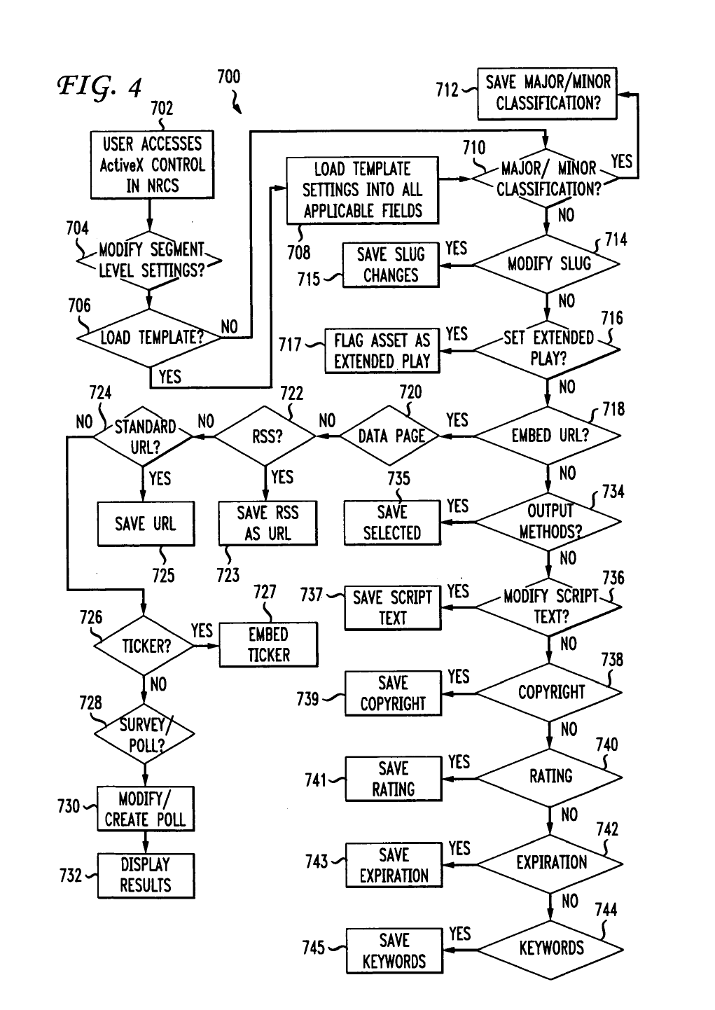

FIG. 4 depicts in flow chart form the steps of an exemplary method 700 for modifying segment data in accordance with the present principles. Initially, a user accesses the ActiveX control in the NRCS 14 of FIG. 1 during step 702, whereupon the user gets the ability to modify segment level settings during step 704. When the user selects the option to modify a segment level setting, the user gets asked whether or not to load a template during step 706. If the user chooses to load the template, the template settings get loaded into all applicable fields during step 708 and the user receives the option to make Major/Minor classifications during step 710.

Since segment information can vary from one segment to the next (e.g., Classifications, ratings, keywords, etc.), the user should have the ability to load and save templates. Default information exists within these templates for ‘all’ applicable fields. Upon selection of a template during step 706, default information automatically gets populated into the various text fields during step 708 and drop down boxes will appear to allow user modification.

To better understand this process, consider the following example wherein a user creates a template for sports show such as a high school basketball game. Such a template will contain the proper Major and Minor classification, the default values for keywords, such as sports, high school, and basketball, as well as a G rating, default 7 day expiration, default copyright, and a sports ticker to populate the Auxiliary data window.

During the template creation process, the user should have the ability to populate two drop down boxes which contain all available major and minor classifications. When a user selects a different major classification, the minor classification drop down box should get updated to reflect the correct minor classifications associated with that major classification. Once selected, the major/minor classification gets saved during step 712.

Often, content that comprises a news story will have a “slug” which takes the form of a non-visually displayed portion that contains information, such as the title and date of the story. In practice, the NRCS 14 of FIG. 1 provides the slug by default. However, the user should have the ability, via a text area, to change the story/slug text for a Web Player. Also, the user should have the ability to mark up the slug text with simple html such as italics and bold and when done, the changes to the slug get saved during step 715.

In a preferred embodiment, the user should possess the ability to select an extended play clip (some times referred to as an “asset) during step 716. Such a clip should undergo display in the form of thumbnails under a pane within the ActiveX control. The thumbnails and associated asset identification (referred to as an “asset ID”) typically undergo automatic retrieval from a Video Server (not shown) attached to broadcast production system 22 of FIG. 1. Upon its selection, the clip gets asset flagged as one having extended play characteristics during step 717, but its asset ID should get inserted into the MOS script information.

In an exemplary embodiment, the user should possess the ability to embed a URL into a Media Stream (e.g., the content stream) during Step 718. A text box should appear that allows the user to manually enter a fully qualified URL. However, several common links typically exist which should to allow the user to easily embed pre-created content into the Media Stream. In addition to the text box for the manual URL, the user should possess the ability to populate a drop down box with applicable available links. More specifically, the user should have the ability to make the following entries:
Data Page (step 720)
Really Simple Syndication (RSS) Feed (step 722)
Ticker (step 724)
   Upon selection of the data page from the URL drop down box during step 720, a list of available data pages should appear for browsing and selection by the user. Upon selection of a data page, the user should possess the ability to preview the page, as well as make modifications to the data page and save them back to the Data Page server via a S.O.A.P. message.

Upon selection of an RSS feed during step 722, the user should receive a drop down list of available known RSS feeds. Typically, there exist one or more RSS feeds. Since a large number of RSS feeds can exist, the Major and Minor classification appear as an argument when requesting the list of feeds to ensure that the available feeds for that story bear a relationship to the content. Once selected, the RSS feed gets saved during step 723 as a URL. The user could opt not to use any automated or pre-defined content within an Auxiliary data window. Thus, the system should provide a text area where the user can manually type in the fully qualified URL for storage during step 725.

The user should have the ability to specify a ticker during step 726 for inclusion in the auxiliary data window. Tickers can have individual branding for specific newscasts, so a 6 PM weather ticker could exist, as well as many varied sub categories of tickers, for example, 6 PM—Financial—Stocks—TMS. For this reason, tickers should possess several levels. In practice, a user receives get a tree break-down that allows the user to browse each individual level until locating a ticker for embedding. If the user selects Ticker during step 726, that ticker gets embedded during step 727.

If the user does not select a Ticker during step 726, then the user typically gets the option to specify a survey during step 728. The user should have the ability to specify a Survey to display within the auxiliary data window. An easy to use interface should allow the user to specify a poll to associate with a story. If a survey does not yet exist, the user should receive an interface similar to that provided by broadcast production system 22 wherein the user can create a new survey and specify both the question, as well as all the answers. The user should have the ability to modify these values after the poll has been created. Further, the user should possess the ability to specify a completed survey whose results appear within a story. As an example, the user might want to specify a survey which ran previously but relates to a current story. The user should possess the ability to call up and display results of a poll.

The user should possess the ability to select individual or multiple output modes. In this regard, the user should receive with several check boxes relative to such output modes such as “Web output”, Mobile devices, archive, etc. The selected output method gets saved during step 735.

The script text should possess a large text area which gets automatically populated by the transcript provided by the NRCS 14 of FIG. 1. However, the user should possess the ability to manually overwrite any transcript information and edit it accordingly. The user should also have the ability to reformat the text and mark it up with simple html such as italics and bold. After selection or modification, the script text gets saved during step 737.

The user should have access to a text field which contains the copyright information. In practice, the show copyright information provides the copyright information in the text field. The user should posses the ability to modify the copyright information on a per segment level. Such copyrights can be predefined and selected via drop down or manually updated via the text field, and then saved during step 739.

The show information automatically provides the rating information but the user should have the ability to select, from a drop down box, a rating specifically for the a story. These ratings should get stored with stories for access from a Web Player (not shown) during searches as well as for display of the available segment list. Any changes or modifications to the rating get saved during step 741.

The show information should automatically provide the default segment expiration but the user should have the ability to modify the expiration of the story. The user will receive a simple graphical calendar allowing the user to change the expiration date of that individual segment. Any changes made by the user get saved during step 743.

In practice, keywords get automatically populated when the user selects a template for the segment. However, the user should have the capability to manually enter keywords into a text area and subsequently save (745) the keywords.

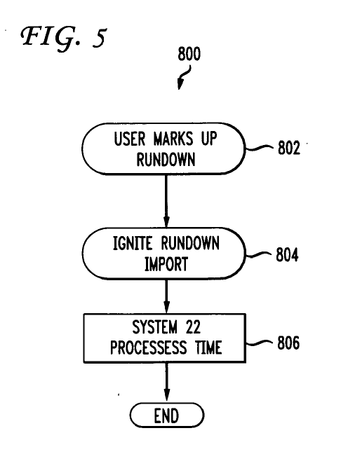

FIG. 5 depicts in flow chart form the steps of an exemplary process in accordance with the present principles via which a user can create a television show and process that show, including content repurposing. During step 802, the user marks up show rundown (e.g., a script) using a pre-production tool. Thereafter, the broadcast production system 22 of FIG. 1 communicates with the NRCS 14 of FIG. 1 and generates a rundown (script) during step 804 during which the broadcast production system can use to execute a transition macro event (TME) during step 806 to repurpose content in the manner described hereinafter.

Those skilled in the art will understand that implementation the present principles can occur in various forms of hardware, software, firmware, special purpose processors, or a combination thereof. Preferably, implementation can occur using a combination of hardware and software. Moreover, such software will typically exist as an application program tangibly embodied on a program storage device. The application program will typically undergo execution by a machine comprising any suitable architecture. Preferably, the machine will comprise a computer platform having hardware such as one or more central processing units (CPU), a random access memory (RAM), and input/output (I/O) interface(s). The computer platform can include an operating system and microinstruction code. The various processes and functions described herein could comprise part of the microinstruction code or part of the application program (or a combination thereof) executed via the operating system. In addition, various other peripheral devices can exist for connection to the computer platform such as an additional data storage device and a printing device.

Those skilled in the art should also appreciate that the function of some of the constituent system components and method steps depicted in the accompanying Figures could exists in software, the actual connections between the system components (or the process steps) could differ depending upon execution of such functions by such software. Given the teachings herein, one of ordinary skill in the related art could easily contemplate these and similar implementations or configurations of the present principles.

The foregoing describes a number of implementations have been described. Nevertheless, those skilled in the art should appreciate that various modifications could occur. For example, elements of different implementations could get combined, supplemented, modified, or removed to produce other implementations. Additionally, one of ordinary skill will understand that other structures and processes could get substituted for those disclosed and the resulting implementations will perform at least substantially the same function(s), in at least substantially the same way(s), to achieve at least substantially the same result(s) as the implementations disclosed. Accordingly, these and other implementations lie within the scope of the following claims.

1. A method for associating metadata for deployment with content video content in the preproduction process, comprising the steps of:
upon receipt of the entry of at least one content segment, establishing metadata needed to repurpose the content segment for distribution;
automatically associating specific metadata with the content segment; and
repurposing the content segment for live distribution in accordance with the established metadata.

2. The method according to claim 1, wherein said step of specifying metadata further comprises:
capturing audio and video;
encoding the captured uncompressed audio and video to create audio-visual content file;
registering a start and an end for at least one segment within audio-visual content; and
recording at least one temporal event within the at least one segment to establish metadata for such segment.

3. The method according to claim 1 wherein the metadata can include at least one of show level settings, show titles, show sub-titles, content rating, content destination, network affiliation, copyright information and disclaimer information.

4. The method according to claim 1 wherein the establishing step includes the step of establishing default metadata.

5. The method according to claim 1 further including the step of modifying the metadata under user command.

6. The method according to claim 1 further including the step of embedding at least one of a data page, a really simple syndication feed and a ticker, into a content stream.

7. The method according to claim 6 further comprising the step of modifying at least one of the data page, a really simple syndication feed and a ticker embedded into the content stream.

8. The method according to claim 1 further comprising the step of deploying the re-purposed content on at least one of a plurality of output modes.

9. The method according to claim 8 further comprising the step of modifying the output mode under user command.

10. A system comprising
means for establishing metadata needed to repurpose a content segment for distribution;
means for automatically associating specific metadata with the content segment; and
means for repurposing the content for live distribution in accordance with the established metadata.
